(19) United States
(12) Patent Application Publication
(10) Pub. No.: US 2025/0005365 A1
(43) Pub. Date: Jan. 2, 2025

(54) NEURAL NETWORK INFERENCE BASED ON TABLE LOOKUP

(71) Applicant: Microsoft Technology Licensing, LLC, Redmond, WA (US)

(72) Inventors: Yang WANG, Beijing (CN); Ting CAO, Beijing (CN); Li ZHANG, Beijing (CN); Qi CHEN, Beijing (CN); Mao YANG, Beijing (CN)

(21) Appl. No.: 18/344,831

(22) Filed: Jun. 29, 2023

(51) Int. Cl. G06N 3/084; G06N 3/047

(52) U.S. Cl. CPC G06N 3/084; G06N 3/047

(57) ABSTRACT

According to implementations of the subject matter described herein, a solution for neural network inference based on table lookup is provided. According to this solution, respective centroids in a first plurality of codebooks for a first layer of a neural network are determined along with a first weight matrix through a training procedure of the neural network. A first input for the first layer is divided into a first plurality of input sub-vectors, and target centroids are determined for the input sub-vectors based on respective distances between the input sub-vectors and the centroids. Target computation results of the target centroids with the first weight matrix are selected from a lookup table. A first output for the first layer is determined based on aggregation of the target computation results. In this way, better model accuracy can be achieved while leveraging the computation acceleration in table lookup-based model inference.

### BACKGROUND

Machine learning techniques, especially deep neural networks (DNN), are widely used in various applications, offering users unparalleled intelligent services. However, neural networks, especially DNNs, are computation hungry workloads, mainly composed of linear computation operators, heavily stressing the limited hardware resources on certain devices such as the mobile devices. It is desirable to provide efficient and affordable neural network inference on devices with limited computation resources.

### SUMMARY

According to implementations of the subject matter described herein, a solution for efficient neural network inference is proposed. In this solution, respective centroids in a first plurality of codebooks for a first layer of a neural network are determined along with a first weight matrix for the first layer through a training procedure of the neural network. A centroid represents a cluster of sub-vectors with matched feature information. A first input for the first layer is divided into a first plurality of input sub-vectors. Respective target centroids for the first plurality of input sub-vectors are determined based on respective distances between the first plurality of input sub-vectors and respective centroids in a first plurality of codebooks for the first layer. Respective target computation results of the respective target centroids with the first weight matrix are selected from a lookup table. The lookup table comprises respective computation results of the respective centroids in the first plurality of codebooks with the first weight matrix. A first output corresponding to the first input for the first layer is determined based on the aggregation of the respective target computation results. In this way, better model accuracy can be achieved while leveraging the computation acceleration in table lookup-based model inference.

The Summary is provided to introduce a selection of concepts in a simplified form that are further described below in the Detailed Description. The Summary is neither intended to identify key features or essential features of the subject matter described herein, nor is it intended to be used to limit the scope of the subject matter described herein.

### BRIEF DESCRIPTION OF THE DRAWINGS

FIG. 1 illustrates a block diagram of an example environment in which various implementations of the subject matter described herein can be implemented;

FIG. 2 illustrates an example process of product quantization (PQ) for approximated matrix multiplication (AMM):

FIG. 3A and FIG. 3B illustrate model accuracy results of using PQ-based AMM for replacing layers of a neural network;

FIG. 4 illustrates a schematic block diagram of an architecture for table lookup-based model inference in accordance with some implementations of the subject matter described herein:

FIG. 5 illustrates a schematic diagram of centroid learning in a backpropagation of a training procedure in accordance with some implementations of the subject matter described herein:

FIG. 6A illustrates an output probability distribution at different learning coefficients for a layer in accordance with some implementations of the subject matter described herein:

FIG. 6B illustrates an example of learned learning coefficients for respective layers of a neural network in accordance with some implementations of the subject matter described herein:

FIG. 7 illustrates a schematic diagram of a table lookup-based model inference flow in accordance with some implementations of the subject matter described herein:

FIG. 8 illustrates a flowchart of a process for model inference in accordance with some implementations of the subject matter described herein; and

FIG. 9 illustrates a schematic block diagram of an electronic device in which various implementations of the subject matter described herein can be implemented.

Throughout the drawings, the same or similar reference symbols refer to the same or similar elements.

### DETAILED DESCRIPTION OF IMPLEMENTATIONS

The subject matter described herein will now be described with reference to some example implementations. It is to be understood that these implementations are described only for the purpose of illustration and help those skilled in the art to better understand and thus implement the subject matter described herein, without suggesting any limitations to the scope of the subject matter described herein.

As used herein, the term “includes” and its variants are to be read as open terms that mean “includes but is not limited to.” The term “based on” is to be read as “based at least in part on.” The terms “an implementation” and “one implementation” are to be read as “at least one implementation.” The term “another implementation” is to be read as “at least one other implementation.” The term “first,” “second,” and the like may refer to different or the same objects. Other definitions, either explicit or implicit, may be included below.

As used herein, the term “model” may learn an association between corresponding input and output from training data, and thus a corresponding output may be generated for a given input after the training. The generation of the model may be based on machine learning techniques. Deep learning (DL) is one of machine learning algorithms that processes the input and provides the corresponding output using a plurality of layers of processing units. A neural network is an example of a deep learning-based model. As used herein, “model” may also be referred to as “machine learning model”, “learning model”, “machine learning network” or “learning network”, which are used interchangeably herein.

Generally, machine learning may roughly include three stages, i.e., a training stage, a test stage, and an application stage (also referred to as an interference stage). In the training stage, a given model may be trained using a large scale of training data, with parameter values being iteratively updated until the model can obtain, from the training data, consistent interference that meets an expected target. Through the training, the model may be considered as being capable of learning the association between the input and the output (also referred to as an input-to-output mapping) from the training data. The parameter values of the trained model are determined. In the test stage, test inputs are applied to the trained model to test whether the model can provide correct outputs, so as to determine the performance of the model. In the interference stage, the model may be utilized to process an actual input based on the parameter values obtained from the training and to determine the corresponding output.

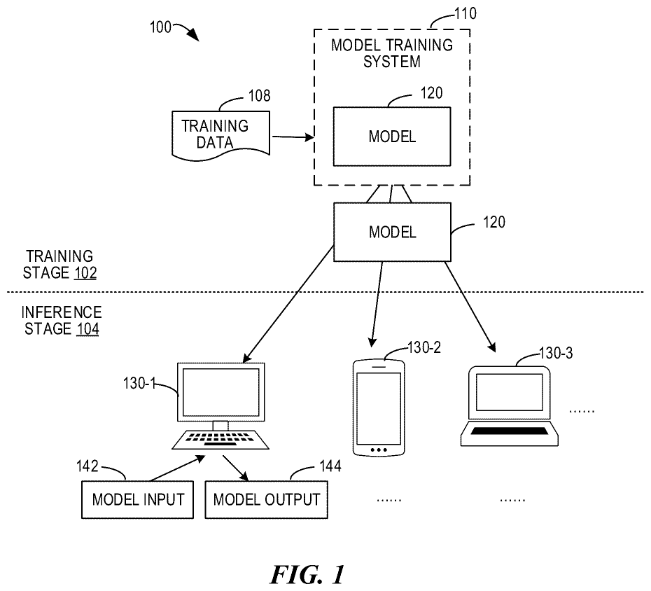

FIG. 1 illustrates a block diagram of an example environment 100 in which various implementations of the subject matter described herein can be implemented. In the environment of FIG. 1, three different stages are shown, including a training stage 102 and an inference stage 104.

In the training stage 102, a model training system 110 is configured to train a machine learning model (i.e., a model 120), which can be configured to learn from training data 108 accurate representations of model inputs (also known as feature representations or features of the model inputs) and to provide desired model outputs based on the representations. Initially, the model 120 may be configured with initial parameter values. During the training process, the initial parameter values of the model 120 may be iteratively updated until a learning objective is achieved.

Through the training stage 102, the model 120 may learn a strong generalization capability from the large scale of training data 108. After the training, a trained model 120 may be obtained. At this time, the parameter values of the trained model 120 may be ready for model inference. It is noted that after the training stage is completed, there may be a test phase during which a test dataset is used to validate the performance of the trained model, which is not shown in the figure.

At the inference stage 104, the trained model 120 may be provided to one or more devices/systems such as electronic devices 130-1, 130-2, and 130-3 (collectively or individually referred to as “electronic devices 130” for purpose of discussion) for model inference. As illustrated, the electronic device 130-1 may receive a model input 142. The trained model 120 may be executed to process the model input 104 to provide a model output 144 corresponding to the model input 142. Similarly, the electronic devices 130-2 and 130-3 may also receive their model inputs for processing by the trained model 120.

In some implementations, the model 120 may be a neural network which comprises a plurality of network layers (or “layers”). A first layer of the model 120 may receive a model input for processing and provide an intermediate output. The output by a layer of the model 120 may be referred to as a feature of the input. The output by the last layer of the model 120 may be referred to as a model output of the model 120.

A layer of the model 120 may include a set of parameter values for processing the input of this layer. The set of parameter values may include weights to be applied to the input of the layer. In some implementations, depending on the configurations and the function types selected, the processing in some layers of the model 120 may be considered as matrix multiplication of the input and the weights. Depending on the cardinality, the input of the layer may include one or more input matrixes, and the weights may include one or more weight matrixes to be multiplicated with the input matrixes. In some implementations, the set of parameter values may further include bias values, which can be added to the products of the matrix multiplication.

In FIG. 1, the model training system 110 and the electronic devices 130 may include any computing system or device with the computing capability, such as various computing devices/systems, terminal devices, servers, and the like. Terminal devices may include any type of mobile terminal, fixed terminal or portable terminal, including mobile phone, desktop computer, laptop computer, netbook computer, tablet computer, media computer, multimedia tablet, or any combination thereof, including accessories and peripherals of these devices or any combination thereof. Servers include but are not limited to mainframe, edge computing nodes, computing devices in a cloud environment, and the like.

It would be appreciated that the components and arrangements in the environment 100 shown in FIG. 1 are only examples, and a computing system suitable for implementing the example implementations described in the subject matter described herein may include one or more different components, other components, and/or different arrangements. For example, although being illustrated as separate systems/devices, the model training system 110 may be integrated with an electronic device 130. The implementations of the subject matter described herein are not limited in this regard. The example implementations of the model training and model application will be further described with reference to the accompanying figures.

On-device Neural Network (NN) inference consumes significant computing resources and development efforts, especially when the layer number increases in Deep Neural Network (DNN). A lot of efforts have been taken for efficient and affordable NN inference on mobile devices, such as model compression, sophisticated computing operator optimization, tensor compilers for operator generation, and customized NN accelerators. These methods require redesigning or reimplementing model structures, computation operators, or accelerators repeatedly for diverse deployment scenarios.

Different from these directions, implementations of the subject matter described herein explore a new possibility to replace computation operators of NNs, for reduced inference cost, as well as the tedious efforts of operator development. During the inference process, each layer of a neural network is to output another level of features given the input features. For example, the front layers of an image recognition model output low-level features (e.g., edges and lines), and subsequent layers output high-level features (e.g., faces and objects). The fact is that the features of different images for each layer have semantic similarities. A vivid example is that though cats and horses are different input images for a model, their ear features result in similar output for the layer that extracts it. Same for language tasks, similar words of different sentences could have similar embeddings and output results.

Based on this similarity, the question is whether the typical features can be learned for each computation operator of the neural network, so that the output of these typical features can represent the output of diverse features. If so, the inventors found that by precomputing and saving the output of typical features, the output of future inputs can be read directly without computation.

Product quantization (PQ) is an effective vector quantization technique used for dataset compression. It compresses the dataset by clustering the vectors in the dataset first, and then learning the centroids to represent vectors in each cluster, which can reduce the cardinality of the dataset. The set of centroids is called a codebook. For vector quantization, the dataset is composed of D-dimension vectors. The vector quantizer can encode each vector to a centroid in the codebook. As such, PQ can decompose the high-dimensional vector space into the Cartesian product of sub-vector spaces and then quantize these sub-vector spaces separately. For example, the D-dimension vector may be split into C distinct V-dimension sub-vectors (D=C·V). The sub-vectors are quantized separately using C codebooks. The quantization result of the vector is the concatenation of the C centroids.

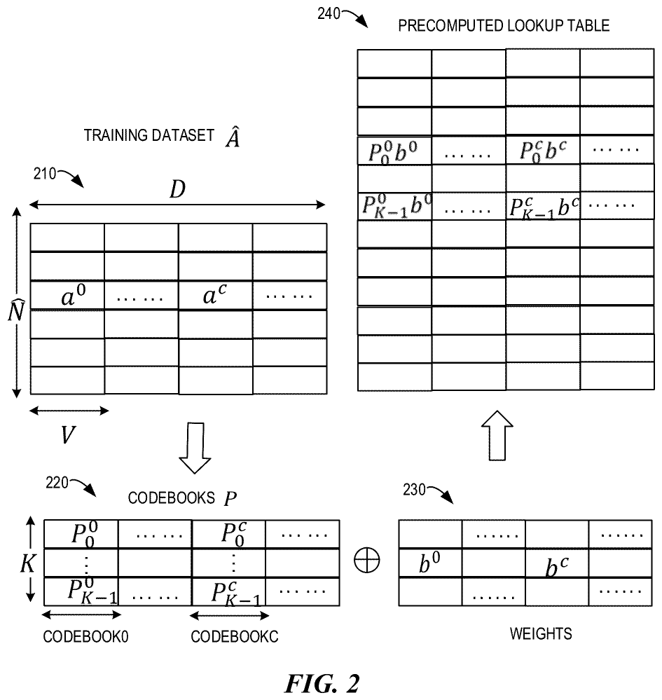

PQ can be used for approximated matrix multiplication (AMM). The process of PQ for AMM may be formulized as follows, with reference to FIG. 2. Each data sample in a training set can be assumed as a vector. To quantize a D-dimension vector a∈ [symbol] ^{D}, the centroids may be learned from a training dataset Â∈ [symbol] ^{\hat{N}×D} 210 composed of vectors with the same distribution as a. PQ first decomposes the vectors in the training dataset Â into C distinct V-dimension sub-vectors, notated as Â^{c} ∈ [symbol] ^{\hat{N}×V}, corresponding to respective columns in the training dataset 210. To make optimal quantization, the centroid learning process is to find the K centroids P^{c} (i.e., the c^{th} codebook) for the sub-vector Â^{c} by k-means, which can minimize the distance sum of each sub-vector Âᵢ^{c} and its nearest centroid Pₖ^{c}, as shown in Eq. (1).

$$arg {min}_{P} {\sum }_{c} {\sum }_{i} {‖ {\hat{A}}_{i}^{c} - {P}_{k}^{c} ‖}^{2} \qquad ( 1 )$$

With the learned centroids P in the codebooks P 220 for all the sub-vectors, PQ can encode it as the concatenation of the nearest centroids for each sub-vector. The encoding function for a sub-vector is shown in Eq. (2). By this vector decomposition method, the centroids can represent KC different vectors by only K×C memory cost.

$${g}^{c} ( {a}^{c} ) = arg {min}_{k} {‖ {a}^{c} - {P}_{k}^{c} ‖}^{2} \qquad ( 2 )$$

Learning centroids is an NP-hard problem. Conventional PQ uses k-means to learn centroids and encode sub-vectors. k-means satisfies Lloyd's optimal conditions and can get a local optimal quantization error. However, the k-means encoding costs high to compute the Euclidean distance for each sub-vector with each centroid, as shown in Eq. (2).

To reduce the encoding cost, some works propose hashing methods to encode sub-vectors, but at the cost of higher quantization error. The hashing method is to hash a sub-vector to one of the K buckets. For example, some solutions propose to select a 4-level balanced binary regression tree of the hashing function family, with each leaf as a hash bucket. A sub-vector is encoded by traversing the tree from the root, and moving to left or right child if the value of certain indices is above or below a threshold.

For a matrix multiplication A×B^{T}, a and b are the rows of A and B, respectively, and can be considered as two vectors. For a layer of a neural network, the matrix A may be the input of this layer (which may be the model input for the first layer or an input feature from a preceding layer), and the matrix B may be the weights for the layer. Various types of layers in the neural network, including the convolution layer, can be considered as matrix multiplication. Since the matrix Bis constant in the context of model inference, the centroid codebooks P 220 are prepared for the matrix A and the multiplication of all the centroids and the matrix B 230 containing the weights may be precomputed to construct a lookup table 240, as shown in FIG. 2. The c^{th} codebook corresponding to a sub-vector Â^{c} contains K centroids P₀^{c}, P₁^{c} . . . . P_{K-1}^{c}. The table construction function h^{c}(b^{c}) for a weight sub-vector be corresponding to an input sub-vector a^{c} is shown in Eq. (3).

$${h}^{c} ( {b}^{c} ) = [ {P}_{0}^{c} \cdot {b}^{c} , {P}_{1}^{c} \cdot {b}^{c} , … , {P}_{K - 1}^{c} \cdot {b}^{c} ] \qquad ( 3 )$$

The matrix multiplication can then be approximated by looking up and aggregating the results of the nearest centroids in the precomputed lookup table, formulated in Eq. (4).

$$a \cdot b = {\sum }_{c} {a}^{c} {b}^{c} \approx {\sum }_{c} {g}^{c} ( {a}^{c} ) \cdot {h}^{c} ( {b}^{c} ) \qquad ( 4 )$$

In Eq. (4), the g^{c}(a^{c}) function is to search for the nearest centroid for the sub-vector a^{c} of the input vector a. The g^{c}(a^{c}) function is an one-hot representation for the argmin function, i.e., the nearest centroid is marked as 1 and others as 0, for example,

$${g}^{c} ( {a}^{c} ) = onehot ( {g}^{c} ( {a}^{c} ) = arg {min}_{k} {‖ {a}^{c} - {P}_{k}^{c} ‖}^{2} ) = ( 0 , … , 0 , 1 , 0 , … , 0 ) .$$

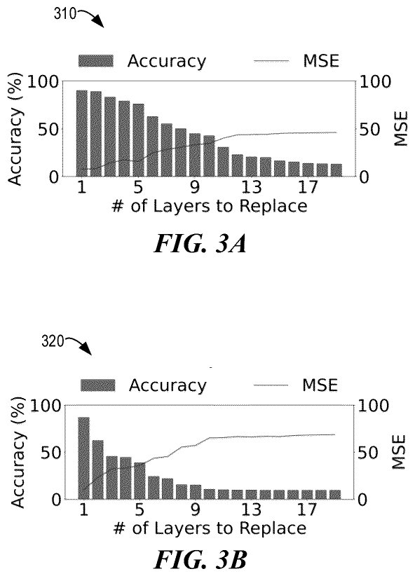

Since neural networks are composed of MM, a direct thought is that MM in the layers of a neural network can be replaced by the PQ-based AMM. However, the inventors have proved that directly applying it to a neural network leads to poor accuracy. FIG. 3A and FIG. 3B show model accuracy results of using PQ-based AMM for replacing layers of a neural network, as well as the Mean Square Error (MSE). MSE is measured based on an error between the model output of the neural network with layers replaced by the PQ-based AM and the model output of the original neural network.

In an example 310 of FIG. 3A, a conventional PQ-based AMM is applied, with k-means for encoding. In an example 320 of FIG. 3B, an improved PQ-based AMM is applied with hashing for encoding acceleration, with bigger error introduced. As shown in FIG. 3A and FIG. 3B, the accuracy keeps dropping while more layers are replaced by AMM, because the error of the AMMs is accumulated.

The inventors explored the reasons for the poor accuracy of PQ-based AMM and found that it may due to the different optimization goals of PQ and neural network learning. As shown in Eq. (1), the goal of PQ is to minimize quantization error, i.e., learn the centroids to minimize the distance of each sub-vector and its nearest centroid. On the other hand, the goal of neural network learning is to minimize the final loss function, through backpropagation to iteratively adjust the model parameters of each layer. The two goals have no direct relationship. Without considering the loss function, when more layers of the neural network apply AMM, the approximation error gets accumulated layer by layer, resulting in poor accuracy, as shown in FIG. 3A and FIG. 3B. This will make the resulting neural network unreliable and undeployable in real-world applications.

In the example implementations of the subject matter described herein, PQ-based AMM is further improved by learning centroids for respective layers of a neural network during a training procedure of the neural network. That is, the centroids are adjusted iteratively together with the weights of the model during the training procedure, until a training objective of the neural network is achieved, e.g., a loss function is minimized or decreased to a target value. As such, the accumulated errors through PQ-based approximation may be decreased or minimized. In this way, better model accuracy can be achieved while leveraging the computation acceleration of PQ-based AMM for table lookup-based model inference.

Some example implementations of the subject matter described herein will be described in more detail below with reference to the accompanying drawings.

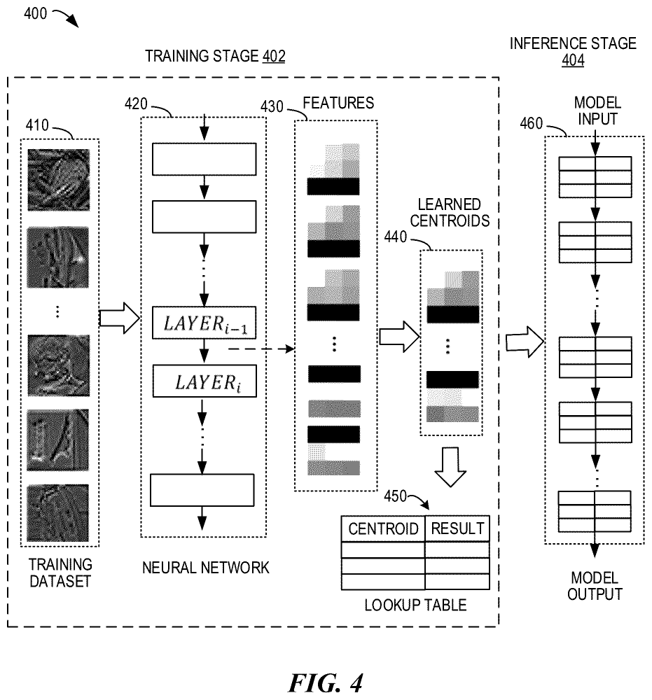

FIG. 4 illustrates a schematic block diagram of an architecture 400 for table lookup-based model inference in accordance with some implementations of the subject matter described herein. The architecture 400 involves a training stage 402 and an inference stage 404. The operations in the training stage 402 described below may be implemented, for example, at the model training system 110 of FIG. 1, and the operations in the inference stage 404 described below may be implemented, for example, an electronic device 130 of FIG. 1.

In the example implementations of the subject matter described herein, instead of directly applying PQ to replace matrix multiplication at respective layers of a neural network, it is proposed to learn centroids for the respective layers of the neural network through a training procedure of the neural network. Thus, the objective of the centroid learning is consistent with the objective of the weight learning, which is to decrease or minimize the loss of the neural network on a training dataset.

As illustrated in FIG. 4, in the training stage 402, a training dataset 410 is obtained to train a neural network 420, which comprises a plurality of layers. The training dataset 410 may comprise a plurality of input samples for the neural network 420. In some examples, if supervised learning techniques are adopted for training, the training dataset 410 may include ground-truth outputs for the respective input samples. In the illustrated example, it is assumed that the neural network 420 is configured to perform a visual task and thus the training dataset comprises images. It would be appreciated that the training dataset for the neural network 420 may be varied depending on the tasks (language task, video task and so on) configured for the neural network 420.

During the training procedure of the neural network 420, a model input (e.g., an input image) from the training dataset 410 may be provided to the first layer of the neural network 420 and the output from one layer may be forward propagated to a next layer of the neural network 420. For example, features 430 output by a layer (Layerᵢ₋₁) may be provided as an input for a next layer (Layerᵢ) of the neural network 420. Following the principle of PQ, to reduce the cardinality of the features 430, centroids 440 may be determined to represent the features 430. It is noted that if Layerᵢ is the first layer of the neural network 420, the input to Layerᵢ is an input sample in the training dataset 410.

For example, it is assumed that the features 430 extracted by Layerᵢ₋₁ from the training dataset 410 is represented as Â∈ [symbol] ^{\hat{N}×D}, with each feature corresponding to a D-dimension vector a∈ [symbol] ^{D} that is extracted from an input sample of the training dataset 410, where \hat{N} represents the number of input samples. A vector a∈ [symbol] ^{D} is an input to be provided to Layerᵢ. As described above, by following the principle of PQ, the vectors in the training dataset Â into C distinct V-dimension sub-vectors, notated as Â^{c}∈ [symbol] ^{\hat{N}×V}, and thus a vector a may be decomposed as into C distinct V-dimension input sub-vectors, notated as a^{c}. The centroid learning process is to determine the K centroids P^{c} for Â^{c}. The K centroids P^{c} for Â^{c} may be included as a codebook (the c^{th} codebook) for Layerᵢ. For C sub-vectors Â^{c}, there may be C codebooks in total, each codebook containing centroids learned for the corresponding sub-vector Â^{c}.

With the centroids in the C codebooks and a weight matrix for Layerᵢ are determined, computation results of the centroids and the weight matrix can be determined and stored in a lookup table 450 for model inference, which is similar as the example shown in FIG. 2. In the lookup table 450, the centroids may be indexed and used to search for corresponding computation results with the corresponding weight sub-vector.

In some implementations, processing at a plurality of layers in the neural network 420 may be replaced by PQ-based AMM. The centroids in a plurality of codebooks for each of the layers may be updated and determined during the training procedure of the neural network 420. In some implementations, the vector dimensions D for different layers may be varied, the number of sub-vectors C may be set as the same or different values for different layers, and the number of centroids K in each codebook may also be set as the same or different values for different layers.

The trained neural network 420 may be provided for inference. At the inference stage 404, a model input is provided to the first layer of the neural network 420 and its output is provided as an input to a next layer. The processing is performed layer by layer. If a layer is replaced by the PQ-based AMM and C codebooks with centroids learned for this layer, then the precomputed lookup table 450 may be utilized to determine an output of this layer. The output determined based on the precomputed lookup table will be described in detail below.

For centroid learning, it is expected that each centroid can represent a cluster of sub-vectors in the features 430, which have matched (or similar) feature information. Instead of directly applying k-means clustering techniques on the features 430, the centroids 440 for the features 430 are iteratively updated during the training procedure with the weight parameters (and possible bias parameters) of the neural network 420.

The training procedure for the neural network 420 may involve a forward propagation and a backpropagation. In example implementations, the weight matrixes and the centroids for the layers of the neural network are both to be updated during the training procedure. Thus, initially, the weight parameters and the centroids may be initialized with random values. In the forward propagation of the training procedure, model inputs in the training dataset are provided to the first layer of the neural network, and the outputs of layers are computed forward throughout the layers of the neural network. Backpropagation works by calculating a model loss at the output and iteratively computing gradients for layers of the neural network backward throughout the layers. Once gradients have been calculated, a number of optimization algorithms can be used to improve the gradients. Example gradient optimizer algorithms may include, but are not limited to, stochastic gradient descent (SGD) algorithms, momentum-based algorithms, or any other optimization algorithms that can speed up training and/or improve convergence.

Accordingly, the centroid learning is to pass the model loss through a backpropagation, and the centroids can be iteratively adjusted by the gradients to minimize the model loss. In some implementations, a loss function may be used to measure the model loss over the training dataset. This loss function may be related to both the weight matrixes of respective layers of the neural network and the centroids for the respective layers. The respective centroids in the codebooks for a layer of the neural network may be updated by decreasing a loss function for training the neural network during a backpropagation of the training procedure.

It may be difficult to learn the centroids through a backpropagation procedure if a vector is encoded to the closest centroid using the argmin function as in Eq. (2) or the hashing function because the argmin or hashing function is not differentiable, and thus the gradient information related to the centroids in the backpropagation is hard to be calculated. In some implementations of the present disclosure, differentiable centroid learning is proposed for the neural network. As will be described below, the differentiable centroid learning may include three mechanisms to adapt three levels of approximation.

In a first mechanism, a soft-PQ mechanism is proposed, which leverages a continuous and differentiable function to replace the argmin function as in Eq. (1), to determine the closest centroid for a sub-vector based on a distance between the centroids and the sub-vectors. With a differentiable introduced, gradients related to the centroids may be determined for the backpropagation. In some implementations, the used differentiable function is the softmax function. The softmax function is considered as approximation to the argmax function, which is the opposite of the argmin function. The output of the softmax function may be a continuous value from a range of, e.g., 0 to 1. Thus, the one-hot centroid result provided by the argmin function may be the weighted sum of all the centroid results.

The use of the softmax function introduces another level of approximation to using the argmin function, which may lead to reduced model accuracy. In some implementations, a second mechanism is proposed to utilize a learnable coefficient to address this challenge, so as to adjust the approximation error of the softmax function with the argmin function for each layer. The learnable coefficient is referred to as an approximation control coefficient or a temperature coefficient, which may be used in the softmax function for each layer and can be determined along with the centroids through the backpropagation in the training procedure.

In a third mechanism, to reduce memory cost of the lookup tables for the layers, scalar quantization may be applied on the lookup tables. This may introduce a level of approximation. Thus, in some implementations, quantization-aware training may be applied to adapt this approximation during centroid learning.

Details of the above three mechanisms will be further discussed blow.

As discussed, conventional PQ employs k-means to learn centroids from the dataset, and the encoding function g^{c}(a^{c}) utilizes the argmin function to encode a sub-vector as the nearest centroid in the codebook, represented by a one-hot vector such as (0 . . . , 1, . . . , 0), with the nearest centroid marked as 1 and others as 0. The sub-vector AMM result can be read directly from the lookup table by g^{c}(a^{c})·h^{c}(b^{c}). However, to apply PQ to the entire neural network and minimize the model loss, the centroids for each layer may be learned from the backpropagation and the gradient information. In some implementations, a smooth and differentiable function, for example, the softmax function, is used as the encoding function for the backpropagation, as shown in Eq. (5). Here, t represents the approximation control coefficient, which will be further discussed in the following.

$${\tilde{g}}^{c} ( {a}^{c} ) = softmax ( - {‖ {a}^{c} - {P}_{k}^{c} ‖}^{2} / t ) \qquad ( 5 )$$

In Eq. (5), ∥a^{c}−Pₖ^{c}∥² is to measure a distance between the centroid Pₖ^{c} and the sub-vector a^{c}. The output of the softmax function is a probability of a centroid Pₖ^{c} being the nearest centroid for the sub-vector a^{c}, which may be valued from a range between 0 and 1.

As mentioned, for a layer of the neural network 420, there may be a total of C codebooks, each codebook containing K centroids. For a codebook with K centroids, the softmax function takes a vector of K distance results between the sub-vector a^{c} and each centroid P as input. It normalizes the input to a probability distribution that adds up to 1. According to the definition of the softmax function, each probability is proportional to the exponent of the distance, i.e., exp(−∥a^{c}−P^{c}∥²/t). The closer the centroid is to the sub-vector, the higher the probability will be. The encoding for a sub-vector is transformed from a deterministic one-hot vector into a probability vector.

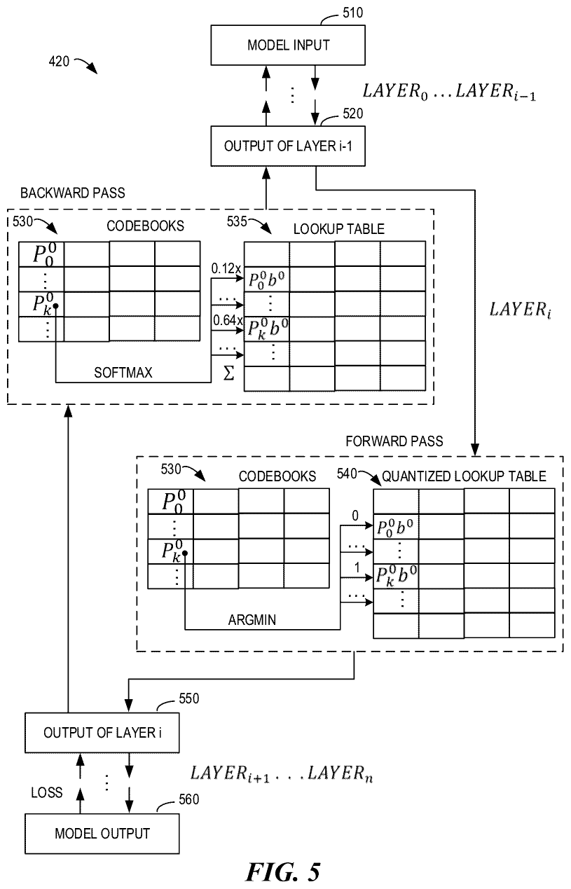

Using the differentiable function (e.g., the softmax function), the centroid learning process of the soft-PQ for the neural network is illustrated in FIG. 5, which shows the backpropagation and forward propagation of the training procedure of the neural network. FIG. 5 illustrates a forward propagation in a forward pass from the first layer Layer₀ to the last layer Layerₙ of the neural network 420. The output from a layer is passed as an input to a next layer. The first layer Layer₀ receives a model input 510 corresponding to a training sample in the training dataset 410 as its input and provides its output to a next layer. FIG. 5 also illustrates a backpropagation in a backward pass from the last Layerₙ to the first layer Layer₀ to decrease or minimize a loss of a model output 560 determined for the model input 510.

FIG. 5 specifically shows the centroid learning of the soft-PQ for a layer Layerᵢ of the neural network 420. For Layerᵢ, in the forward pass of the training procedure, it may receive a sample input a corresponding to a training sample, which may be an output 520 from its preceding layer, Layerᵢ₋₁. If Layerᵢ is Layer₀, i.e., i=0, it may receive the model input 510 in the training dataset 410 as its input. The sample input for Layerᵢ may be divided into (sample input sub-vectors, a^{c}, each associated with one of C codebooks 530 to be learned for Layerᵢ. It is noted that more than one layer of the neural network 420 may be replaced with AMM and thus similar centroid learning of the soft-PQ may be applied.

In the backward pass of the training procedure, the loss function is determined based at least in part on respective probabilities for the respective centroids in the C codebooks for Layerᵢ a probability for a centroid in a codebook indicating a probability that the closet centroid for a sample input sub-vector a^{c} associated with the c^{th} codebook. For example, as illustrated in FIG. 5, the output of the softmax encoding function is (0.12, . . . , 0.64, . . . ), where 0.12 or 0.64 is a probability of a centroid Pₖ^{c} is the nearest centroid for a sample input sub-vector a^{c}. The sub-vector AMM result is then obtained as the dot product of the probabilities and the computation results Pₖ^{c}·b^{c} in the lookup table 535. In the forward pass of the training procedure, the output of Layerᵢ is determined in a same way as for model inference. That is, the closest centroid for a sample input sub-vector a^{c} may be determined through the argmin function. For example, as in illustrated in FIG. 5, the g^{c}(a^{c}) function is a one-hot representation, i.e., the nearest centroid is marked as 1 and others as 0, for example, g^{c}(a^{c})=onehot(g^{c}(a^{c})=arg minₖ∥a^{c}−Pₖ^{c}∥²)=(0, . . . , 0, 1, 0, . . . , 0).

Using the softmax function, the centroid learning process of the soft-PQ for the entire model is illustrated in FIG. 4. During the forward pass, the one-hot argmin function is utilized to calculate the model output and loss, as model inference will also use argmin for simplicity. The backward pass utilizes the softmax function as the encoding function to calculate gradients, adjust centroids via gradient descent, and rebuild lookup tables with the updated centroids for the next training iteration. Based on Eq. (4), the sub-vector AMM in soft-PQ is formulated as Eq. (6).

$${a}^{c} {b}^{c} = {\tilde{g}}^{c} ( {a}^{c} ) \cdot {h}^{c} ( {b}^{c} ) - s g ( {\tilde{g}}^{c} ( {a}^{c} ) \cdot {h}^{c} ( {b}^{c} ) - {g}^{c} ( {a}^{c} ) \cdot {h}^{c} ( {b}^{c} ) ) \qquad ( 6 )$$

Here, sg represents the stop gradient operator. It serves as an identity function during the forward pass to enable the use of g^{c}(a^{c}) encoding in the argmin function. During the backward pass, it drops gradients inside it to enable g^{c}(a^{c}) to generate gradients via the softmax function.

The initial values for the centroids are also important for learning convergence and accuracy. In some implementations, the centroids learned by k-means from conventional PQ may be used to initialize the centroids in the codebooks 530 and the lookup table 535. In some implementations, the centroids in the codebooks 530 may be initialized by clustering a set of sample inputs for Layerᵢ corresponding to a set of training samples in the training dataset 410 for the neural network 420. The lookup table 535 may be determined based on the initialized centroids and the initialized weight matrix for Layerᵢ.

As mentioned above, in some implementations, a learnable approximation control coefficient t is introduced in the softmax function to control the approximation error of the softmax function with the argmin function for each layer. The approximation control coefficient t is learned during the training procedure for each layer of the neural network 420. The differentiable function, e.g., the softmax function in Eq. (5), is related to this approximation control coefficient t. This approximation control coefficient t is configured to control a distribution of probabilities for centroids in a codebook. In some implementations, the approximation control coefficient t may be valued from a range between 0 and 1.

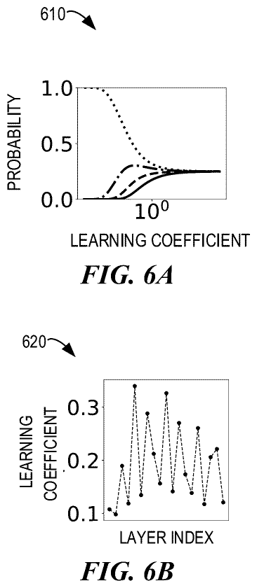

FIG. 6A illustrates an output probability distribution 610 at different values of approximation control coefficient for a layer. As shown, as

$${softmax ( x )}_{i} = \frac{exp ( {x}_{i} / t )}{{Σ}_{k = 1}^{K} exp ( {x}_{k} / t )} ,$$

if t approaches infinity (t→∞), softmax (x)ᵢ approaches 1/K, i.e., the output probability distribution approaches a uniform distribution. If t approaches zero (t→∞), softmax (x)ᵢ approaches onehot (argmax(x)), i.e., the probability of the largest x approaching 1 and the others is 0.

Therefore, there is a tradeoff between small and large approximation control coefficient. By introducing the approximation control coefficient t in the softmax function, for a small approximation control coefficient, the output of the softmax function is close to the one-hot argmax, but the training may be difficult since the variance of gradients is large. For a larger approximation control coefficient, the approximation error is increased, but the variance of gradients is smaller.

Works before normally set the approximation control coefficient t as a fixed value (mostly 1), or anneal it from a large number to a small one during training, but never analyze how to set it reasonably. This is because currently for a neural network, the softmax function is only used by the output layer to produce class probability, or used by the input layer to produce symbol embedding. The approximation error barely impacts the neural network accuracy. However, the soft-PQ in the implementations of the present disclosure employs the softmax function in respective layers of the neural network. The accumulated error may decrease accuracy without proper/settings. Thus, in some implementations, the approximation control coefficient t may also be learned for each layer, also during backpropagation while centroid learning. FIG. 6B illustrates a curve 620 showing an example learned t for each layer for a neural network. The value of t for each layer is different, and thus not practical to tune by hand. According to the accuracy experiments, training with the learned approximation control coefficient spends a few number of iterations of training with the approximation control coefficient setting to 1 to achieve higher accuracy.

In some implementations, the third mechanism for the differentiable centroid learning is to apply scalar quantization during centroid learning. Lookup tables are generally the main disk and memory cost. In some implementations, the table size may be reduced by scalar quantization (e.g., FP32 to INT8). In some examples, the classic range-based linear quantization. The formula is r=s(q−z), in which r is the real value, s is the scaling factor, q is the quantized value, and z is the zero point. In some examples, the symmetric quantization is used, so z may be set as 0, and the quantized range is [−2ⁿ^{^{−1}}, 2ⁿ^{^{−1}}−1]. The scaling factor sis calculated as the max absolute value in the lookup table divided by half of the range, i.e.,

$$s = \frac{max ( value )}{{2}^{n - 1} - 1} ,$$

where “value” represents the max absolute value.

Quantized lookup tables introduce another level of approximation. Similar to the approximation control coefficient, the tables are quantized during centroid learning to minimize the loss function. In some implementations, as shown in FIG. 5, the backpropagation uses the lookup table 535 in real values, so that the centroids in the codebooks 530 can be adjusted in small amounts. The forward pass uses the quantized lookup table 540 as in the model inference to determine an output 550 of Layerᵢ, so as to calculate the loss for the training sample. The quantized lookup table 540 are determined through scalar quantization of the lookup table 535. In the training procedure, as the centroids in the codebooks 530 are iteratively updated, and the weight matrixes for the layers of the neural network 420 are iteratively updated, the lookup table 535 is also iteratively updated.

In each iteration of updates, an intermediate version of the lookup table 535 (referred to as an intermediate lookup table) is generated and used for the backpropagation in the backward pass. This intermediate lookup table includes intermediate real-value computation results of respective intermediate centroids in the codebooks 530 with an intermediate weight matrix for each layer. Scalar quantization is applied on the intermediate lookup table to generate an intermediate quantized lookup table (an intermediate version of the quantized lookup table 540) to be used during a forward propagation in the forward pass. The intermediate quantized lookup table includes respective intermediate quantized computation results of the respective intermediate centroids in the codebooks 530 with the intermediate weight matrix for each layer. Results have shown that by such learning method, the quantized lookup table has little impact on the model accuracy.

The centroid learning in the training procedure of the neural network 420 has been discussed above. In some implementations, computation results of the learned centroids in the cookbooks for a layer of the neural network 420 and the weight matrix for the same layer are determined to construct a lookup table for the layer. The centroids in the codebooks and the lookup table may be stored for use in inference of the neural network 420. In some implementations, to reduce disk and memory cost, scalar quantization is applied to the lookup table to generate a quantized lookup table, which includes quantized computation results of the centroids with first weight matrix. The quantized lookup table is stored for use in inference of the neural network 420. For all the layers of the neural network 420 that are configured to be replaced by the AMM results, the centroids and lookup tables may be obtained and stored in a similar way.

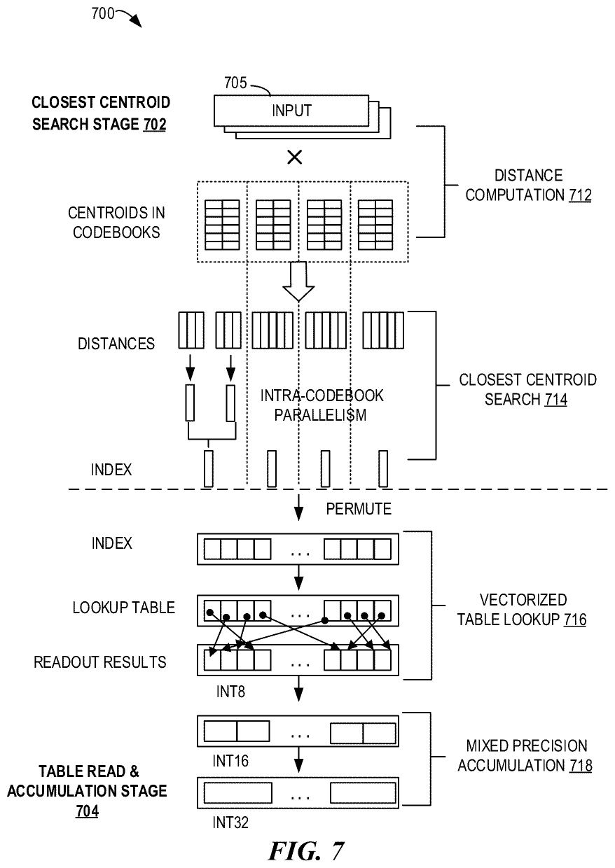

The model inference may be implemented on-device, for example, at an electronic device 130 in the environment 100 of FIG. 1. FIG. 7 illustrates a schematic diagram of a table lookup-based model inference flow 700 in accordance with some implementations of the subject matter described herein. It is assumed that the flow 700 refers to table lookup-based inference for Layerᵢ of the neural network 420. The flow 700 involves a closest centroid search stage 702 and a table read and accumulation stage 704. In some implementations, the features of hardware architectures may be taken into account to optimize the implementations of table lookup-based model inference. As will be discussed below; these optimizations improve inference by utilizing memory hierarchy, utilizing shuffle instructions, and/or utilizing mixed-precision accumulation instructions.

For Layerᵢ of the neural network 420, its input 705 may include one or more matrixes (e.g., an input tensor), represented as A, and its weight matrix may be referred as B. In the closest centroid search stage 702, the input 705 for Layerᵢ is divided into a number of input sub-vectors. The number of the input sub-vectors depends on the number (C) of codebooks learned for Layerᵢ. Each input sub-vector may thus be associated with a codebook. From each codebook with K centroids, a target centroid may be determined for the associated input sub-vectors. The centroid selection is performed based on measuring respective distances between an input sub-vector and the K centroids in the corresponding codebook. Thus, as shown in FIG. 7, a distance computation step 712 is to determine distances between an input sub-vector and the K centroids in the corresponding codebook. As a centroid may also be in form of a vector, the distance may be measured based on the Euclidean distance. In a closest centroid search step 714, according to the determined distances, a closest centroid may be selected as a target centroid for an input sub-vector.

The centroid search may consume relatively high computation costs. Thus, efficient centroid search can improve performance efficiency compared to conventional computational methods. In some implementations, in the closest centroid search step 714 the distances between the input 705 (including a plurality of input sub-vectors) and the centroids may be first calculated. This calculation may be represented as matrix multiplications of the input sub-vectors and codebook matrices. Then, it searches for the nearest centroids for each input sub-vector.

In some cases, the design of centroid search may present challenges that involve leveraging the features of some hardware architectures. First, the distance computation is irregular-shaped (tall-and-skinny) and difficult to optimize using some widely used libraries such as the Basic Linear Algebra Subprograms (BLAS) libraries. For example, it is found that certain optimized reference operators in the XNNPACK library achieves only 23.0 GFLOP/s (Giga Floating-point Operations Per Second) on Pixel 6 for the second layer of LUT-NN based ResNet18, which accounts for only 25.7% of peak performance. The tensor height of the input 705 (N) is usually much larger than the length of the input sub-vector (NV>>V) and the number of centroids (N>>K) on each codebook. Therefore, the operation intensity of the distance calculation can be approximated by

$$\frac{2 N V K}{N V + K V + N K} \approx \frac{2}{1 / K + 1 / V} F LOP / Byte .$$

Since the length of the sub-vector and the number of centroids are small as compared with the height of the input in the neural network, the operation intensity

$$\frac{2}{1 / K + 1 / V}$$

is also small. The distance computation becomes a relatively memory-intensive matrix multiplication.

Therefore, memory access for centroid distance computations in the distance computation step 712 may be optimized to leverage memory hierarchy in hardware. In some implementations, to optimize memory access for centroid distance computations in the distance computation step 712, the memory access overhead may be reduced by keeping frequently accessed data in registers and caches as much as possible. In some implementations, since centroid matrices have small sizes, a centroid-stationary computation scheme may be applied to reside centroid matrices in registers and reorder centroid matrix loads in the inner loop to keep them in the cache as long as possible. The centroid-stationary computation keeps K centroids in the cache for each codebook, which only requires reading these centroids once from the memory. For example, if an inference service for the neural network 420 is activated on the electronic device 130, the codebooks may be stored in a cache. Consequently, it requires reading an N·V input tensor from memory once in the distance computation step 712, reducing memory bandwidth costs and improving performance.

In some implementations, as mentioned above, after computing the centroid distances, the closest centroid search stage 702 may identify the nearest centroid for each input sub-vector and generate the centroid index in the closest centroid search step 714. It can be represented by an argmin function, which determines an index with the shortest distance. However, searching for the nearest centroid for each input sub-vector is a data-dependent operation. To find the closest one, each distance may be compared sequentially, which is RAW (Read After Write) dependent and hard to be parallelized on the processing units, e.g., central processing units (CPUs). In some implementations, it is proposed to apply intra-codebook parallelism to optimize the closest centroid search stage. Intra-codebook parallelism searches the nearest centroid for the input sub-vector on a codebook in parallel. Specifically, a codebook may be sliced into multiple sub-codebooks and each distance between the input sub-vector and centroids may be compared in each sub-codebook. For example, a plurality of candidate target centroids from the plurality of sub-codebooks based on parallel distance comparison for the plurality of sub-codebooks, where the parallel distance comparison is configured to compare distances between the first input sub-vector and respective centroids in the plurality of sub-codebooks. Then, the execution result from each sub-codebook may be interleaved, to avoid data dependency in closest centroid search. The compared distances may be merged by reduction and find the index corresponding to the closest centroid. For example, a target centroid for the first input sub-vector may be determined from the plurality of candidate target centroids by comparing distances between the first input sub-vector and the plurality of candidate target centroids. In this way, instruction-level parallelism is leveraged to improve hardware utilization and performance.

With (target centroids determined for the (input sub-vectors of the input 705, in the table read and accumulation stage 704, respective target computation results of the respective target centroids with a weight matrix for Layerᵢ may be selected from the lookup table. For example, computation results in the lookup table may be indexed with the respective centroids. The indices of the target centroids for the input sub-vectors after the closest centroid search may be used in the table read and accumulation stage 704 to compute the final result for Layerᵢ. The target computation results may thus be selected from the lookup table using the indices of the target centroid. A computation result may be a product of a centroid with a corresponding weight sub-vector in the weight matrix. The lookup table may be stored and the target computation results may be read from the stored lookup table. In some implementations, as mentioned above, the lookup table used for model inference may be a quantized lookup table containing quantized computation results. Accordingly, target quantized computation results may be selected for the target centroids.

An output for corresponding to the input for Layerᵢ is then determined based on aggregation of the respective target computation results. The table read and accumulation stage may include a table lookup step to read the pre-computed results from the corresponding lookup table through indices of the target centroids (the closest centroids) and an accumulation step to accumulate the pre-computed results by an accumulation operation. For example, convolution operators directly read out filter's outputs from lookup tables and accumulate each input channel's result for output channels.

In some cases, the table read and accumulation stage 704 may introduce additional overhead in inference. In some implementations, the inference efficiency may be further enhanced by skillfully utilizing widely available and supported instructions in hardware. First, a table read is difficult to parallelize and introduces additional indirect memory accesses, which exaggerate the memory overhead on lookup tables. Since the lookup table may be quantized into integers in a certain range (e.g., INT8 in some examples), leverage shuffle instructions, which are widely supported in the instruction set, e.g., in the Single Instruction Multiple Data (SIMD) instruction set, can be leveraged to achieve parallel and efficient table read. The implementation of table read using shuffle instructions in FIG. 7. In a vectorized table lookup step 716, the shuffle instruction permutes each byte of a vector based on an index vector and stores the shuffled bytes in the result vector register in each clock cycle. In an example, on 128-bit wide SIMD, a vectorized table read instruction handles 16 sub-vector lookups (128/8=16) on 16 results (128/8=16) simultaneously, greatly simplifying table read and reducing overheads.

In some cases, the accumulation of the target computation results may have comparable computation costs to the entire process. For example, when a codebook handles N index lookups on a K·M lookup table, it costs N·M table reads (K=16) and N·M accumulation adds. Therefore, the quantized lookup table leaves accumulation operations as the performance bottleneck of table reads. The number of parallel processing units within a SIMD instruction is called SIMD lanes. In some implementations, the number of centroids may be set based on the number of SIMD lanes. For example, the number of centroids may be set to 16 (K=16) to maximize the utilization of all SIMD instruction lanes. Since a higher number of SIMD lanes leads to higher throughput on the same width of SIMD instruction (e.g., the quantized INT16 add instruction has the half throughput of INT8 on a 128-bit SIMD), the accumulation throughput may be maximized by a mixed precision accumulation step 718. It first accumulates computation results in INT16 to utilize more SIMD lanes and then gathers computation results in INT16 to computation results in INT32 to avoid overflow.

It would be appreciated that the byte lengths of the integers (e.g., INT8, INT16, INT32) illustrated in FIG. 7 are provided as examples, and any other suitable length may be configured.

The theoretical floating point operations per second (FLOPs) and model size reduction by the table lookup-based model inference proposed herein. The two primary factors of the model inference are the number of centroids and the length of sub-vectors, representing a tradeoff between cost and accuracy. The analysis with these two factors is as follows. According to the output formula Eq. (4) of a PQ-based AMM in the model inference proposed herein, the main cost is from the encoding function g^{c}(a^{c}), which calculates the Euclidean distance of the sub-vector with each centroid. After that, the cost is from table lookup with the encoding result (i.e., index of the closest centroid), and the result aggregation of sub-vectors. For file size, the major cost is from the lookup tables, which saves the dot product result of each centroid and the according sub-vectors in the weight matrix. The size of codebooks is relatively small, since the sub-vectors on the same column share one codebook.

Therefore, the FLOPs of encoding, table lookup and aggregation, as well as the size of lookup tables are analyzed as the cost of the model inference proposed herein, to compare it with normal MM in below Table 1. It is assumed that the neural network is a convolution model for image processing. Since convolution can be transformed to MM by an im2col function, its cost also follows these formulas. For a convolution, M is the number of output channels, D is the number of input channels×filter size², and NV is height×width.

TABLE 1
FLOPs and disk size of an AMM-based model
inference proposed herein compared to normal MM
A ∈ [symbol] ^{N}^{×D}: an input matrix for a layer
B ∈ [symbol] ^{D}^{×M}: a weight matrix for the layer
V: the length of an input sub-vector a^{c} divided from the input matrix
K: the number of centroids in a codebook for a^{c}

| | Model inference proposed herein | Normal MM |
|---|---|---|
| FLOPs | N · D · K + N · M · D/V | N · D · M |
| Disk size | 4 · D · K + D · M · K/V | 4 · D · M |

The number of centroids K and the sub-vector length V are two hyperparameters for the model inference proposed herein. They are tradeoffs between accuracy and cost. The more centroids K and shorter sub-vector V may lead to higher accuracy, but will increase the cost of the model inference. Experiments on different model show that some typical settings, for example, (K=8, V=9) and (K=16, V=9), can achieve comparable accuracy with the original model, and also align with the SIMD width for high performance. Similar to other hyperparameters in DNN training, K and V can be set by grid search, evolutionary search, or other popular methods considering the cost budget. It is clear that the model inference proposed herein can achieve both computation and model size saving. The FLOPs saving is because K is normally smaller than M. For example, the number of output channels i.e., M, for ResNet50 (an example image processing model) is normally 128, 256, or 512, so the FLOPs can be reduced by 4 times when K=8. For ResNet20 (another example image processing model), the number of output channel is 16, 32, and 64, so the FLOPs is reduced by 2 times when K=8.

According to the implementations of the subject matter described herein, the improved solution for table lookup-based model inference has been proposed. A new paradigm potentially brings significant benefits to the DNN inference ecosystem, simplifying the inference software and hardware design and decoupling with the DNN algorithm updates. By the centroid learning technique for DNN, it achieves comparable accuracy for complex tasks with much less resource cost.

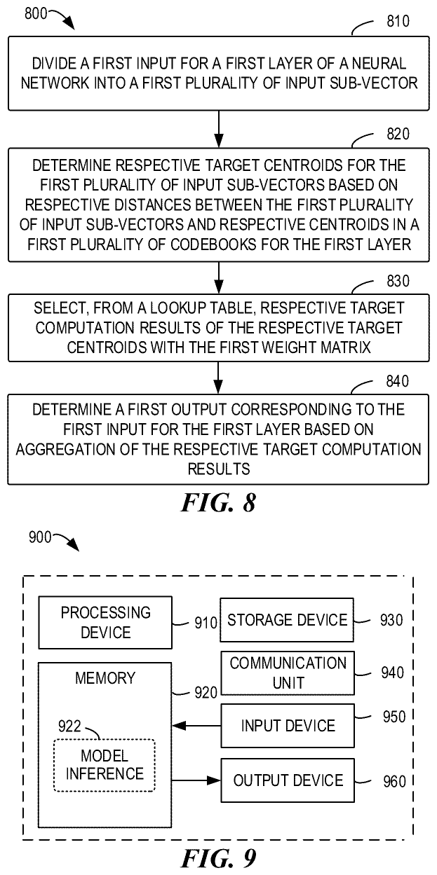

FIG. 8 illustrates a flowchart of a process 800 for model inference in accordance with some implementations of the subject matter described herein. The process 800 may be implemented at an electronic device 130 of FIG. 1.

At block 810, the electronic device 130 divides a first input for a first layer of a neural network into a first plurality of input sub-vectors. At block 820, the electronic device 130 determines respective target centroids for the first plurality of input sub-vectors based on respective distances between the first plurality of input sub-vectors and respective centroids in a first plurality of codebooks for the first layer. A centroid represents a cluster of sub-vectors with matched feature information, and the respective centroids in the first plurality of codebooks are determined along with a first weight matrix for the first layer through a training procedure of the neural network.

At block 830, the electronic device 130 selecting, from a lookup table, respective target computation results of the respective target centroids with the first weight matrix, the lookup table comprising respective computation results of the respective centroids in the first plurality of codebooks with the first weight matrix.

At block 840, the electronic device 130 determines a first output corresponding to the first input for the first layer based on aggregation of the respective target computation results.

In some implementations, the respective centroids in the first plurality of codebooks are updated by decreasing a loss function for training the neural network during a backpropagation of the training procedure.

In some implementations, a sample input for the first layer corresponding to a training sample is divided into a first plurality of sample input sub-vectors, a sample input sub-vector for the first layer is associated with one of the first plurality of codebooks. In some implementations, the loss function is determined based at least in part on respective probabilities for the respective centroids in the first plurality of codebooks, a probability for a centroid in a codebook indicating a probability that the centroid is closet to a sample input sub-vector associated with the codebook relative to other centroids in the codebook.

In some implementations, the probability for the centroid in the codebook is determined through a differentiable function, the differentiable function being determined based at least in part on a distance between the centroid and the sample input sub-vector. In some implementations, the respective centroids in the first plurality of codebooks are updated through a backpropagation based on gradient information generated via the differentiable function.

In some implementations, the differentiable function is determined further based on a learning coefficient for the first layer, the learning coefficient is configured to control a distribution of probabilities for centroids in a codebook, and is determined along with the respective centroids in the first plurality of codebooks through the training procedure of the neural network.

In some implementations, the differentiable function is a softmax function.

In some implementations, the respective centroids in the first plurality of codebooks are initialized in the training procedure by clustering a set of sample inputs for the first layer corresponding to a set of training samples in a training dataset for the neural network.

In some implementations, the lookup table is a quantized lookup table comprising respective quantized computation results of the respective centroids in the first plurality of codebooks with the first weight matrix.

In some implementations, an intermediate lookup table is used during a backpropagation of the training procedure, the intermediate lookup table comprising respective intermediate real-value computation results of respective intermediate centroids in the first plurality of codebooks with an intermediate weight matrix for the first layer. In some implementations, an intermediate quantized lookup table is used during a forward propagation of the training procedure, the intermediate quantized lookup table comprising respective intermediate quantized computation results of the respective intermediate centroids in the first plurality of codebooks with the intermediate weight matrix for the first layer.

In some implementations, the process 800 further comprises: in accordance with a determination that an inference service for the neural network is activated, storing the first plurality of codebooks in a cache.

In some implementations, a first codebook of the first plurality of codebooks is divided into a plurality of sub-codebooks, a sub-codebook comprising two or more centroids, the first codebook being associated with a first input sub-vector of the first plurality of input sub-vectors. In some implementations, determining the respective target centroids comprises: selecting a plurality of candidate target centroids from the plurality of sub-codebooks based on parallel distance comparison for the plurality of sub-codebooks, the parallel distance comparison is configured to compare distances between the first input sub-vector and respective centroids in the plurality of sub-codebooks; and determining a target centroid for the first input sub-vector from the plurality of candidate target centroids by comparing distances between the first input sub-vector and the plurality of candidate target centroids.

In some implementations, a second plurality of codebooks are determined for a second layer of the neural network, respective centroids in the second plurality of codebooks being determined along with a second weight matrix for the second layer through the training procedure of the neural network.

FIG. 9 illustrates a schematic block diagram of an electronic device 900 in which various implementations of the subject matter described herein can be implemented. It would be appreciated that the electronic device 900 as shown in FIG. 9 is merely provided as an example, without suggesting any limitation to the functionalities and scope of implementations of the subject matter described herein.

As shown in FIG. 9, the electronic device 900 is in form of a general-purpose computing device. Components of the electronic device 900 may include, but are not limited to, one or more processors or processing devices 910, a memory 920, a storage device 930, one or more communication units 940, one or more input devices 950, and one or more output devices 960.

In some implementations, the electronic device 900 may be implemented as a device with computing capability, such as a computing device, a computing system, a server, a mainframe and so on.

The processing device may can be a physical or virtual processor and can execute various processing based on the programs stored in the memory 920. In a multi-processor system, a plurality of processing units execute computer-executable instructions in parallel so as to enhance the parallel processing capability of the electronic device 900. The processing device 910 may include a central processing unit (CPU), a graphics processing unit (GPU), a microprocessor, a controller, and/or a microcontroller, etc.

The electronic device 900 usually includes various computer storage medium. Such medium may be any available medium accessible by the electronic device 900, including but not limited to, volatile and non-volatile medium, or detachable and non-detachable medium. The memory 920 may be a volatile memory (for example, a register, cache, Random Access Memory (RAM)), non-volatile memory (for example, a Read-Only Memory (ROM), Electrically Erasable Programmable Read-Only Memory (EEPROM), a flash memory), or any combination thereof. The storage device 930 may be any detachable or non-detachable medium and may include computer-readable medium such as a memory, a flash memory drive, a magnetic disk or any other medium that can be used for storing information and/or data and are accessible by the electronic device 900.

The electronic device 900 may further include additional detachable/non-detachable, volatile/non-volatile memory medium. Although not shown in FIG. 9, there may be provided a disk drive for reading from or writing into a detachable and non-volatile disk, and an optical disk drive for reading from and writing into a detachable non-volatile optical disc. In such cases, each drive may be connected to a bus (not shown) via one or more data medium interfaces.

The communication unit 940 implements communication with another computing device via communication medium. In addition, the functionalities of the components in the electronic device 900 may be implemented by a single computing cluster or a plurality of computing machines that can communicate with each other via communication connections. Thus, the electronic device 900 may operate in a networked environment using a logic connection with one or more other servers, network personal computers (PCs), or further general network nodes.

The input device 950 may include one or more of a variety of input devices, such as a mouse, keyboard, data import device and the like. The output device 960 may be one or more output devices, such as a display, data export device and the like. By means of the communication unit 940, the electronic device 900 may further communicate with one or more external devices (not shown) such as storage devices and display devices, one or more devices that enable the user to interact with the electronic device 900, or any devices (such as a network card, a modem and the like) that enable the electronic device 900 to communicate with one or more other computing devices, if required. Such communication may be performed via input/output (I/O) interfaces (not shown).

In some implementations, as an alternative of being integrated on a single device, some or all components of the electronic device 900 may also be arranged in the form of cloud computing architecture. In the cloud computing architecture, the components may be provided remotely and work together to implement the functionalities described in the subject matter described herein. In some implementations, the cloud computing provides computing, software, data access and storage service, which will not require end users to be aware of the physical locations or configurations of the systems or hardware provisioning these services. In various implementations, the cloud computing provides the services via a wide area network (such as Internet) using proper protocols. For example, a cloud computing provider provides applications over the wide area network, which may be accessed through a web browser or any other computing components. The software or components of the cloud computing architecture and corresponding data may be stored in a server at a remote position. The computing resources in the cloud computing environment may be aggregated or distributed at locations of remote data centers. Cloud computing infrastructure may provide the services through a shared data center, though they behave as a single access point for the users. Therefore, the cloud computing infrastructure may be utilized to provide the components and functionalities described herein from a service provider at remote locations. Alternatively, they may be provided from a conventional server or may be installed directly or otherwise on a client device.

The electronic device 900 may be used to implement resource management in accordance with various implementations of the subject matter described herein. The memory 920 may include one or more modules having one or more program instructions. These modules may be accessed and run by the processing unit 910 to perform functions of various implementations described herein. For example, the memory 920 may include a model inference module 922 for performing table lookup-based model inference according to example implementations of the subject matter described herein. The electronic device 900 may obtain an input required through the input device 950 and provide an output through the output device 960. In some implementations, the electronic device 900 may further receive an input from other device (not shown) via the communication unit 940.

Some example implementations of the subject matter described herein are listed below:

In an aspect, the subject matter described herein provides a computer-implemented method. The method comprises: dividing a first input for a first layer of a neural network into a first plurality of input sub-vectors: determining respective target centroids for the first plurality of input sub-vectors based on respective distances between the first plurality of input sub-vectors and respective centroids in a first plurality of codebooks for the first layer, a centroid representing a cluster of sub-vectors with matched feature information, and the respective centroids in the first plurality of codebooks being determined along with a first weight matrix for the first layer through a training procedure of the neural network: selecting, from a lookup table, respective target computation results of the respective target centroids with the first weight matrix, the lookup table comprising respective computation results of the respective centroids in the first plurality of codebooks with the first weight matrix; and determining a first output corresponding to the first input for the first layer based on aggregation of the respective target computation results.

In some implementations, the respective centroids in the first plurality of codebooks are updated by decreasing a loss function for training the neural network during a backpropagation of the training procedure.

In some implementations, a sample input for the first layer corresponding to a training sample is divided into a first plurality of sample input sub-vectors, a sample input sub-vector for the first layer is associated with one of the first plurality of codebooks, and the loss function is determined based at least in part on respective probabilities for the respective centroids in the first plurality of codebooks, a probability for a centroid in a codebook indicating a probability that the centroid is closet to a sample input sub-vector associated with the codebook relative to other centroids in the codebook.

In some implementations, the probability for the centroid in the codebook is determined through a differentiable function, the differentiable function being determined based at least in part on a distance between the centroid and the sample input sub-vector, and the respective centroids in the first plurality of codebooks are updated through a backpropagation based on gradient information generated via the differentiable function.

In some implementations, the differentiable function is determined further based on a learning coefficient for the first layer, the learning coefficient is configured to control a distribution of probabilities for centroids in a codebook, and is determined along with the respective centroids in the first plurality of codebooks through the training procedure of the neural network.

In some implementations, the differentiable function is a softmax function.

In some implementations, the respective centroids in the first plurality of codebooks are initialized in the training procedure by clustering a set of sample inputs for the first layer corresponding to a set of training samples in a training dataset for the neural network.

In some implementations, the lookup table is a quantized lookup table comprising respective quantized computation results of the respective centroids in the first plurality of codebooks with the first weight matrix.

In some implementations, an intermediate lookup table is used during a backpropagation of the training procedure, the intermediate lookup table comprising respective intermediate real-value computation results of respective intermediate centroids in the first plurality of codebooks with an intermediate weight matrix for the first layer; and an intermediate quantized lookup table is used during a forward propagation of the training procedure, the intermediate quantized lookup table comprising respective intermediate quantized computation results of the respective intermediate centroids in the first plurality of codebooks with the intermediate weight matrix for the first layer.

In some implementations, the method further comprises: in accordance with a determination that an inference service for the neural network is activated, storing the first plurality of codebooks in a cache.

In some implementations, a first codebook of the first plurality of codebooks is divided into a plurality of sub-codebooks, a sub-codebook comprising two or more centroids, the first codebook being associated with a first input sub-vector of the first plurality of input sub-vectors, and wherein determining the respective target centroids comprises: selecting a plurality of candidate target centroids from the plurality of sub-codebooks based on parallel distance comparison for the plurality of sub-codebooks, the parallel distance comparison is configured to compare distances between the first input sub-vector and respective centroids in the plurality of sub-codebooks; and determining a target centroid for the first input sub-vector from the plurality of candidate target centroids by comparing distances between the first input sub-vector and the plurality of candidate target centroids.

In some implementations, a second plurality of codebooks are determined for a second layer of the neural network, respective centroids in the second plurality of codebooks being determined along with a second weight matrix for the second layer through the training procedure of the neural network.

In another aspect, the subject matter described herein provides an electronic device. The electronic device comprises: a processor; and a memory coupled to the processor and comprising instructions stored thereon which, when executed by the processor, cause the device to perform acts comprising: dividing a first input for a first layer of a neural network into a first plurality of input sub-vectors: determining respective target centroids for the first plurality of input sub-vectors based on respective distances between the first plurality of input sub-vectors and respective centroids in a first plurality of codebooks for the first layer, a centroid representing a cluster of sub-vectors with matched feature information, and the respective centroids in the first plurality of codebooks being determined along with a first weight matrix for the first layer through a training procedure of the neural network: selecting, from a lookup table, respective target computation results of the respective target centroids with the first weight matrix, the lookup table comprising respective computation results of the respective centroids in the first plurality of codebooks with the first weight matrix; and determining a first output corresponding to the first input for the first layer based on aggregation of the respective target computation results.

In some implementations, the respective centroids in the first plurality of codebooks are updated by decreasing a loss function for training the neural network during a backpropagation of the training procedure.

In some implementations, a sample input for the first layer corresponding to a training sample is divided into a first plurality of sample input sub-vectors, a sample input sub-vector for the first layer is associated with one of the first plurality of codebooks, and the loss function is determined based at least in part on respective probabilities for the respective centroids in the first plurality of codebooks, a probability for a centroid in a codebook indicating a probability that the centroid is closet to a sample input sub-vector associated with the codebook relative to other centroids in the codebook.

In some implementations, the probability for the centroid in the codebook is determined through a differentiable function, the differentiable function being determined based at least in part on a distance between the centroid and the sample input sub-vector, and the respective centroids in the first plurality of codebooks are updated through a backpropagation based on gradient information generated via the differentiable function.

In some implementations, the differentiable function is determined further based on a learning coefficient for the first layer, the learning coefficient is configured to control a distribution of probabilities for centroids in a codebook, and is determined along with the respective centroids in the first plurality of codebooks through the training procedure of the neural network.

In some implementations, the differentiable function is a softmax function.

In some implementations, the respective centroids in the first plurality of codebooks are initialized in the training procedure by clustering a set of sample inputs for the first layer corresponding to a set of training samples in a training dataset for the neural network.

In some implementations, the lookup table is a quantized lookup table comprising respective quantized computation results of the respective centroids in the first plurality of codebooks with the first weight matrix.

In some implementations, an intermediate lookup table is used during a backpropagation of the training procedure, the intermediate lookup table comprising respective intermediate real-value computation results of respective intermediate centroids in the first plurality of codebooks with an intermediate weight matrix for the first layer; and an intermediate quantized lookup table is used during a forward propagation of the training procedure, the intermediate quantized lookup table comprising respective intermediate quantized computation results of the respective intermediate centroids in the first plurality of codebooks with the intermediate weight matrix for the first layer.

In some implementations, the acts further comprise: in accordance with a determination that an inference service for the neural network is activated, storing the first plurality of codebooks in a cache.

In some implementations, a first codebook of the first plurality of codebooks is divided into a plurality of sub-codebooks, a sub-codebook comprising two or more centroids, the first codebook being associated with a first input sub-vector of the first plurality of input sub-vectors, and wherein determining the respective target centroids comprises: selecting a plurality of candidate target centroids from the plurality of sub-codebooks based on parallel distance comparison for the plurality of sub-codebooks, the parallel distance comparison is configured to compare distances between the first input sub-vector and respective centroids in the plurality of sub-codebooks; and determining a target centroid for the first input sub-vector from the plurality of candidate target centroids by comparing distances between the first input sub-vector and the plurality of candidate target centroids.

In some implementations, a second plurality of codebooks are determined for a second layer of the neural network, respective centroids in the second plurality of codebooks being determined along with a second weight matrix for the second layer through the training procedure of the neural network.

In yet another aspect, the subject matter described herein provides a computer program product that is tangibly stored in a computer storage medium and comprises computer executable instructions that, when executed by a device, cause the device to perform acts comprising: dividing a first input for a first layer of a neural network into a first plurality of input sub-vectors: determining respective target centroids for the first plurality of input sub-vectors based on respective distances between the first plurality of input sub-vectors and respective centroids in a first plurality of codebooks for the first layer, a centroid representing a cluster of sub-vectors with matched feature information, and the respective centroids in the first plurality of codebooks being determined along with a first weight matrix for the first layer through a training procedure of the neural network: selecting, from a lookup table, respective target computation results of the respective target centroids with the first weight matrix, the lookup table comprising respective computation results of the respective centroids in the first plurality of codebooks with the first weight matrix; and determining a first output corresponding to the first input for the first layer based on aggregation of the respective target computation results.

In some implementations, the computer executable instructions that, when executed by a device, cause the device to perform one or more example implementations of the method in the above aspect.

In yet another aspect, the subject matter described herein provides a non-transitory computer-readable medium having computer executable instructions stored thereon that, when executed by a device, cause the device to perform one or more example implementations of the method of the above aspect.

The functionalities described herein can be performed, at least in part, by one or more hardware logic components. As an example, and without limitation, illustrative types of hardware logic components that can be used include field-programmable gate arrays (FPGAs), Application-specific Integrated Circuits (ASICs), application-specific standard products (ASSPs), system-on-a-chip systems (SOCs), complex programmable logic devices (CPLDs), and the like.

Program code for carrying out the methods of the subject matter described herein may be written in any combination of one or more programming languages. The program code may be provided to a processor or controller of a general-purpose computer, special purpose computer, or other programmable data processing flowchart such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of the subject matter described herein, a machine-readable medium may be any tangible medium that may contain or store a program for use by or in connection with an instruction execution system, flowchart, or device. The machine-readable medium may be a machine-readable signal medium or a machine-readable storage medium. A machine-readable medium may include but is not limited to an electronic, magnetic, optical, electromagnetic, infrared, or semiconductor system, flowchart, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

I/We claim:

1. A computer-implemented method, comprising:
dividing a first input for a first layer of a neural network into a first plurality of input sub-vectors;
determining respective target centroids for the first plurality of input sub-vectors based on respective distances between the first plurality of input sub-vectors and respective centroids in a first plurality of codebooks for the first layer, a centroid representing a cluster of sub-vectors with matched feature information, and the respective centroids in the first plurality of codebooks being determined along with a first weight matrix for the first layer through a training procedure of the neural network;
selecting, from a lookup table, respective target computation results of the respective target centroids with the first weight matrix, the lookup table comprising respective computation results of the respective centroids in the first plurality of codebooks with the first weight matrix; and
determining a first output corresponding to the first input for the first layer based on aggregation of the respective target computation results.

2. The method of claim 1, wherein the respective centroids in the first plurality of codebooks are updated by decreasing a loss function for training the neural network during a backpropagation of the training procedure.

3. The method of claim 2, wherein a sample input for the first layer corresponding to a training sample is divided into a first plurality of sample input sub-vectors, a sample input sub-vector for the first layer is associated with one of the first plurality of codebooks, and
wherein the loss function is determined based at least in part on respective probabilities for the respective centroids in the first plurality of codebooks, a probability for a centroid in a codebook indicating a probability that the centroid is closet to a sample input sub-vector associated with the codebook relative to other centroids in the codebook.

4. The method of claim 3, wherein the probability for the centroid in the codebook is determined through a differentiable function, the differentiable function being determined based at least in part on a distance between the centroid and the sample input sub-vector, and
wherein the respective centroids in the first plurality of codebooks are updated through a backpropagation based on gradient information generated via the differentiable function.

5. The method of claim 4, wherein the differentiable function is determined further based on a learning coefficient for the first layer, the learning coefficient is configured to control a distribution of probabilities for centroids in a codebook, and is determined along with the respective centroids in the first plurality of codebooks through the training procedure of the neural network.

6. The method of claim 3, wherein the differentiable function is a softmax function.

7. The method of claim 3, wherein the respective centroids in the first plurality of codebooks are initialized in the training procedure by clustering a set of sample inputs for the first layer corresponding to a set of training samples in a training dataset for the neural network.

8. The method of claim 1, wherein the lookup table is a quantized lookup table comprising respective quantized computation results of the respective centroids in the first plurality of codebooks with the first weight matrix.

9. The method of claim 1, wherein an intermediate lookup table is used during a backpropagation of the training procedure, the intermediate lookup table comprising respective intermediate real-value computation results of respective intermediate centroids in the first plurality of codebooks with an intermediate weight matrix for the first layer; and
wherein an intermediate quantized lookup table is used during a forward propagation of the training procedure, the intermediate quantized lookup table comprising respective intermediate quantized computation results of the respective intermediate centroids in the first plurality of codebooks with the intermediate weight matrix for the first layer.

10. The method of claim 1, further comprising:
in accordance with a determination that an inference service for the neural network is activated, storing the first plurality of codebooks in a cache.

11. The method of claim 1, wherein a first codebook of the first plurality of codebooks is divided into a plurality of sub-codebooks, a sub-codebook comprising two or more centroids, the first codebook being associated with a first input sub-vector of the first plurality of input sub-vectors, and wherein determining the respective target centroids comprises:
selecting a plurality of candidate target centroids from the plurality of sub-codebooks based on parallel distance comparison for the plurality of sub-codebooks, the parallel distance comparison is configured to compare distances between the first input sub-vector and respective centroids in the plurality of sub-codebooks; and
determining a target centroid for the first input sub-vector from the plurality of candidate target centroids by comparing distances between the first input sub-vector and the plurality of candidate target centroids.

12. The method of claim 1, wherein a second plurality of codebooks are determined for a second layer of the neural network, respective centroids in the second plurality of codebooks being determined along with a second weight matrix for the second layer through the training procedure of the neural network.

13. An electronic device comprising:
a processor; and
a memory coupled to the processor and comprising instructions stored thereon which, when executed by the processor, cause the device to perform acts comprising:
dividing a first input for a first layer of a neural network into a first plurality of input sub-vectors;
determining respective target centroids for the first plurality of input sub-vectors based on respective distances between the first plurality of input sub-vectors and respective centroids in a first plurality of codebooks for the first layer, a centroid representing a cluster of sub-vectors with matched feature information, and the respective centroids in the first plurality of codebooks being determined along with a first weight matrix for the first layer through a training procedure of the neural network;
selecting, from a lookup table, respective target computation results of the respective target centroids with the first weight matrix, the lookup table comprising respective computation results of the respective centroids in the first plurality of codebooks with the first weight matrix; and
determining a first output corresponding to the first input for the first layer based on aggregation of the respective target computation results.

14. The device of claim 13, wherein the respective centroids in the first plurality of codebooks are updated by decreasing a loss function for training the neural network during a backpropagation of the training procedure.

15. The device of claim 14, wherein a sample input for the first layer corresponding to a training sample is divided into a first plurality of sample input sub-vectors, a sample input sub-vector for the first layer is associated with one of the first plurality of codebooks, and
wherein the loss function is determined based at least in part on respective probabilities for the respective centroids in the first plurality of codebooks, a probability for a centroid in a codebook indicating a probability that the centroid is closet to a sample input sub-vector associated with the codebook relative to other centroids in the codebook.

16. The device of claim 15, wherein the probability for the centroid in the codebook is determined through a differentiable function, the differentiable function being determined based at least in part on a distance between the centroid and the sample input sub-vector, and
wherein the respective centroids in the first plurality of codebooks are updated through a backpropagation based on gradient information generated via the differentiable function.

17. The device of claim 16, wherein the differentiable function is determined further based on a learning coefficient for the first layer, the learning coefficient is configured to control a distribution of probabilities for centroids in a codebook, and is determined along with the respective centroids in the first plurality of codebooks through the training procedure of the neural network.

18. The device of claim 14, wherein the differentiable function is a softmax function.

19. The device of claim 13, wherein the lookup table is a quantized lookup table comprising respective quantized computation results of the respective centroids in the first plurality of codebooks with the first weight matrix.

20. A computer program product that is tangibly stored in a computer storage medium and comprises computer executable instructions which, when executed by a device, cause the device to perform acts comprising:
dividing a first input for a first layer of a neural network into a first plurality of input sub-vectors;
determining respective target centroids for the first plurality of input sub-vectors based on respective distances between the first plurality of input sub-vectors and respective centroids in a first plurality of codebooks for the first layer, a centroid representing a cluster of sub-vectors with matched feature information, and the respective centroids in the first plurality of codebooks being determined along with a first weight matrix for the first layer through a training procedure of the neural network;
selecting, from a lookup table, respective target computation results of the respective target centroids with the first weight matrix, the lookup table comprising respective computation results of the respective centroids in the first plurality of codebooks with the first weight matrix; and
determining a first output corresponding to the first input for the first layer based on aggregation of the respective target computation results.
